(19) United States
(12) Patent Application Publication
(10) Pub. No.: US 2025/0189939 A1
(43) Pub. Date: Jun. 12, 2025

(54) METHOD, APPARATUS AND SYSTEM FOR CLOSED-LOOP CONTROL OF A MANUFACTURING PROCESS

(71) Applicant: CAMBRIDGE ENTERPRISE LIMITED, Cambridge (GB)

(72) Inventors: Douglas Antony James BRION, London (GB); Sebastian William PATTINSON, Cambridge (GB)

(73) Assignee: CAMBRIDGE ENTERPRISE LIMITED, Cambridge (GB)

(21) Appl. No.: 18/846,155

(22) PCT Filed: Mar. 21, 2023
(86) PCT No.: PCT/GB2023/050707

§ 371 Date: Sep. 11, 2024

(30) Foreign Application Priority Data
Mar. 23, 2022 (GB) 2204072.9

(51) Int. Cl. G05B 13/02; G06T 1/00; G06V 10/774

(52) U.S. Cl. CPC G05B 13/027; G06T 1/0014; G06V 10/774; G06V 2201/06

(57) ABSTRACT

Broadly speaking, embodiments of the present techniques provide a method, apparatus and system for automatically detecting and correcting errors in manufacturing parameters of a manufacturing process using closed-loop control. Advantageously, the present techniques not only monitor manufacturing parameters but also provide instructions to enable any unacceptable variation in a manufacturing parameter to be corrected during the manufacturing process.

### FIELD

The present techniques generally relate to automated error detection and correction during manufacturing processes. In particular, the present techniques provide a method, apparatus and system for automatically detecting and correcting errors during additive manufacturing processes.

### BACKGROUND

Additive manufacturing (AM), also frequently referred to as 3D printing, is a method of producing parts and devices via the sequential layering of material. Manufacturing items with this approach enables the fabrication of complex geometries and structures which are unachievable with traditional manufacturing methodologies. Additive manufacturing offers vast opportunities to design and manufacture complex devices with the technology being used in numerous applications from healthcare and medical devices to aerospace and robotics. So far, the technology has enabled rapid prototyping and product development and has now begun to be used for end-use production parts. However, the vast capabilities afforded to AM by its large design and parameter space also leave vulnerability to manufacturing errors. Thus, a single part often requires multiple iterations to achieve a successful print, wasting valuable material, energy, and time. For each of these errors an experienced human operator is required to assess the cause of the errors and subsequently adjust the appropriate parameters. Hence, automation of the manufacturing process not only has the potential to speed up the manufacturing process but also to reduce the number of personnel required for successful operation.

Moreover, manufacturing parameters vary between printers and can change significantly depending on the chosen material. New materials for AM, including cells, nanocomposites, or cement in construction, continue to be developed. Many of these materials are very sensitive to printing conditions but at the same time are intended to be used in such non-ideal conditions. Such complex manufacturing conditions include being printed into complex lattices, printing in less stable environments (e.g. outside or onto bodies), or in multi-material structures, providing more opportunities for errors.

The applicant has therefore identified the need for improved techniques for automatic closed-loop control of a manufacturing process.

### SUMMARY

In a first approach of the present techniques, there is provided a computer-implemented method for closed-loop control of a manufacturing process, the method comprising: receiving, at predefined time intervals during the manufacturing process, at least one image of the manufacturing process; processing, using a trained machine learning, ML, model, the at least one image at each time interval to predict a value of at least one manufacturing parameter associated with the manufacturing process; determining whether the predicted value of the at least one manufacturing parameter is within a predefined range of values; and generating instructions for corrective action when the predicted value is outside the predefined range of values.

Advantageously, the present techniques not only monitor manufacturing parameters but also provide instructions to enable any unacceptable variation in a parameter to be corrected during the manufacturing process or after a current iteration of the manufacturing process has ended (ahead of beginning a subsequent iteration). In contrast, many existing approaches only monitor the parameters but do not automatically correct for variations.

Advantageously, a single trained ML model is used to process the image(s) and predicting a value of the manufacturing parameter(s). This is advantageous relative to known methods that use separate models to analyse the images and predict parameters (which may therefore be slower or require more computational resources to implement, and which may be more difficult to train).

Furthermore, the present techniques monitor manufacturing parameters while the manufacturing process is taking place, in real-time or near real-time. This means that if the manufacturing parameters are acceptable, it is assumed that the manufacturing process is proceeding correctly and so there is no need to pause the process to inspect the object being manufactured. Similarly, if one or more manufacturing parameters is unacceptable, corrective action can be taken in real-time or near real-time. For manufacturing parameters that cannot be corrected in real-time or near real-time, the present techniques enable corrective action to be taken between iterations of the manufacturing process. Consequently, this can make the manufacturing process more time efficient. It may also be more energy and material efficient because, for example, the number of faulty objects being produced may be reduced. In contrast, existing approaches often require the manufacturing process to be paused so that object being manufactured can be inspected, which can introduce significant delays in the manufacturing process.

The at least one manufacturing parameter is a parameter of the manufacturing process that may be varied or controlled. The at least one manufacturing parameter may depend on the manufacturing process being used. Broadly speaking, the manufacturing parameter may be a parameter that can be controlled or corrected in real-time or near real-time, or a parameter which can only be controlled or corrected between iterations of the manufacturing process. For example, a manufacturing parameter that can be corrected in real-time may be a printing parameter (e.g. flow rate, speed, etc.), and a manufacturing parameter that can be corrected between iterations may be a toolpath/slicing parameter.

For example, when the manufacturing process is a material extrusion process, the at least one parameter may be any one or more of: flow rate; lateral speed/feed rate; Z offset; hotend temperature; bed temperature; layer height; line width; infill density; wall thickness; and a retraction setting. It will be understood this is a non-exhaustive and non-limiting list of manufacturing parameters.

In another example, when the manufacturing process is a stereolithography (SLA) process, the at least one parameter may be any one or more of: exposure time; lifting speed; lifting distance; light off delay; layer height; wall thickness; and infill density. These parameters are all types of parameters which can be corrected in real-time or near real-time. It will be understood this is a non-exhaustive and non-limiting list of manufacturing parameters.

In another example, when the manufacturing process is a laser powder bed fusion (LPBF) process, such as selective laser sintering (SLS) or selective laser melting (SLM), the at least one parameter may be any one or more of: laser power; scan speed; hatch distance; stripe width; stripe overlap; layer height; and laser spot size. It will be understood this is a non-exhaustive and non-limiting list of manufacturing parameters.

In another example, when the manufacturing process is a milling or turning process that may use a mill or lathe, the at least one parameter may be any one or more of: feed rate; spindle speed; cutting depth; cutting width; coolant; and cutter choice (e.g. number of flutes/depth). It will be understood this is a non-exhaustive and non-limiting list of manufacturing parameters.

In another example, when the manufacturing process is a laser cutting process, the at least one parameter may be any one or more of: laser power; feed rate/scan speed; and focal length/height of laser. It will be understood this is a non-exhaustive and non-limiting list of manufacturing parameters.

In another example, when the manufacturing process is a plasma cutting process, the at least one parameter may be any one or more of: arc current; arc voltage; cutting speed; and nozzle height. It will be understood this is a non-exhaustive and non-limiting list of manufacturing parameters.

The step of determining whether the predicted value of the at least one manufacturing parameter is within a predefined range of values may comprise using a range of values that has been set by human experts. That is, human experts who are familiar with the manufacturing process may know how far a manufacturing parameter can deviate without impacting the quality or integrity of the manufactured object. The human experts may also identify which specific manufacturing parameters are important in the development of errors in particular manufacturing processes, as well as the values of those manufacturing parameters that will likely cause an error to develop. Thus, the predefined range of values for each manufacturing parameter being monitored and controlled may be provided to the model during the training stage and/or to use during inference/run-time.

The step of generating instructions for corrective action may comprise generating instructions to adjust a value of at least one manufacturing parameter. This may be useful when, despite the at least one manufacturing parameter having deviated outside of the predefined range of acceptable values, the manufacturing process has not been adversely affected yet. For example, when the manufacturing process involves 3D printing an object, if the object has not been adversely affected or damaged by the deviation of the at least one manufacturing parameter, then it may be useful to correct/adjust the parameter(s) and continue 3D printing the object. In this case, the method may comprise: receiving confirmation that the value of the at least one manufacturing parameter has been adjusted; and processing at least one image using the trained machine learning, ML, model, that is received after the confirmation has been received.

Alternatively, the step of generating instructions for corrective action may comprise generating instructions to abort the current manufacturing process. This may be useful when the deviation of the at least one manufacturing parameter outside of the predefined range of acceptable values causes the manufacturing process to be adversely affected. It may also be useful when the manufacturing parameter that needs correcting cannot be corrected in real-time or near real-time. For example, when the manufacturing process involves 3D printing an object, when the object has been adversely affected or damaged by the deviation of the at least one manufacturing parameter, then it may not be useful to continue 3D printing the object. Instead, it may be efficient to stop 3D printing the object, in terms of cost, time, energy and materials. The manufacturing process may be restarted from the beginning. To avoid the same error from occurring when the next iteration of the manufacturing process is started, the step of generating instructions for corrective action (when the predicted value of the at least one manufacturing parameter is outside the predefined range of values) may be performed before the next iteration is started. Thus, the manufacturing parameter is corrected between iterations of the manufacturing process.

The step of generating instructions for corrective action when the predicted value is outside the predefined range of values may comprise using actions defined by human experts. That is, the instructions may be generated based on heuristics provided by an expert human. This is advantageous because although the model may be able to detect an error, it may not know the best way to correct the error, whereas human experts in the particular manufacturing process being controlled would know how best to correct the error. Human operators of manufacturing processes are routinely required to assess the cause of errors, adjust the appropriate parameters, and re-start the processes. Thus, as explained below, the model may be trained using images that are labelled with manufacturing parameters, and expert-informed heuristics, which enable the model to generate the instructions to correct the error.

The step of receiving at least one image at predefined time intervals may comprise receiving at least one image at predefined time intervals of between one and ten seconds. In some cases, the at least one image may be received at predefined time intervals of less than a second. For example, an image sensor may be used to capture images at a rate of 30 frames per second (30 fps). It will be understood that these are example, non-limiting predefined time intervals, and any suitable time interval may be used.

It may be useful to receive the at least one image at predefined time intervals throughout a manufacturing process, such that the whole duration of the manufacturing process is monitored and controlled. However, often, when an error (i.e. a deviation of at least one manufacturing parameter) occurs at the beginning of a manufacturing process, it may adversely affect the rest of the process if it is not corrected or correctable. Thus, it may be useful to monitor the beginning of (i.e. an initial part of) a manufacturing process because if an error occurs at this stage, it may be more efficient to correct the at least one parameter or to abort the process, in terms of cost, time, energy and materials. Thus, receiving at least one image at predefined time intervals may comprise receiving at least one image at predefined time intervals during at least an initial part of the manufacturing process.

The method may further comprise: sending instructions to pause the manufacturing process; and performing the processing, determining and generating steps while the manufacturing process is paused. This may be useful because the manufacturing process does not continue using potentially unacceptable manufacturing parameters.

Processing the at least one image using a trained machine learning, ML, model may comprise processing the at least one image using a classification module of the trained ML model to predict a value of the at least one manufacturing parameter. In this case, the classification module may classify the value of the at least one manufacturing parameter using discrete classification bins. For example, the flow rate may be classified as “low”, “good” or “high”. Alternatively, processing the at least one image using a trained machine learning, ML, model may comprise using a regression module to predict a value of the at least one manufacturing parameter. In this case, a continuous prediction may be output for a manufacturing parameter. For example, the flow rate may be classified as “37%”, “102%” or “274%”.

In some cases, the method may be performed in real-time, to enable real-time control of the manufacturing process. In these cases, the corrective action is performed in real-time or near real-time with respect to a current iteration of the manufacturing process. This may be possible if the trained machine learning model is, for example, part of or local to an apparatus used to perform the manufacturing process.

Alternatively, the method may be performed after a current iteration of the manufacturing process has ended, to enable control of a subsequent iteration of the manufacturing process. In these cases, the corrective action is performed with respect to the subsequent iteration of the manufacturing process. This may be useful if the trained machine learning model is, for example, not part of or local to an apparatus used to perform the manufacturing process. For instance, if the trained ML model is remote to the apparatus (e.g. located on a remote or cloud server), the time to transmit the images to the remote server, and the time to transmit the instructions for corrective action back to the apparatus may be too long for the manufacturing process to be effectively controlled in real-time or near real-time. As such, it may be more useful to use the information received for one iteration of the manufacturing process to control another, subsequent, iteration. This may also be useful when the corrective action is to abort the current iteration of the manufacturing process. In another example, an error in at least one manufacturing parameter may build over time (e.g. during an iteration of the manufacturing process), and/or the parameter may not be correctable in real-time. For example, errors such as cracking and warp deformation, where stresses in the object being manufactured build over time, cannot be corrected in real-time. In this case, corrective action can only be taken with respect to the subsequent iteration of the manufacturing process.

As mentioned above, the present control method may be suitable for a variety of manufacturing processes. For example, the manufacturing process may be an extrusion-based 3D printing process. It will be understood that this is an example and non-limiting manufacturing process. When the manufacturing process is an extrusion-based 3D printing process, the at least one manufacturing parameter may be any of: a flow rate; a lateral speed or feed rate; a Z-axis offset; a hotend temperature; a bed temperature; a layer height; a line width; an infill density; a wall thickness; and a retraction setting. It will be understood this is a non-exhaustive and non-limiting list of manufacturing parameters.

In a second approach of the present techniques, there is provided an apparatus for performing a manufacturing process using closed-loop control, the apparatus comprising: at least one processor coupled to memory and arranged to: receive, at predefined time intervals during the manufacturing process, at least one image of the manufacturing process; process, using a trained machine learning, ML, model, the at least one image at each time interval to predict a value of at least one manufacturing parameter associated with the manufacturing process; determine whether the predicted value of the at least one manufacturing parameter is within a predefined range of values; and generate instructions for corrective action when the predicted value is outside the predefined range of values.

The apparatus may further comprise at least one image capture device for capturing the at least one image of the manufacturing process at predefined time intervals. The image capture device may be any one of: a camera; an optical sensor; and an infra-red sensor or camera.

The apparatus may be any one of: an extrusion-based 3D printer; an additive manufacturing apparatus; a material extrusion apparatus; a stereolithography apparatus; a laser powder bed fusion apparatus; a milling apparatus; a turning apparatus; a lathe; a laser cutter; and a plasma cutter. It will be understood that this is a non-exhaustive list of possible apparatus.

In a third approach of the present techniques, there is provided a system for closed-loop control of a manufacturing process, the system comprising: an apparatus for performing the manufacturing process, the apparatus comprising: at least one image capture device for capturing at least one image of the manufacturing process at predefined time intervals; and a communication module for transmitting the at least one image for processing; and a remote server comprising at least one processor coupled to memory and arranged to: receive the at least one image of the manufacturing process from the apparatus; process, using a trained machine learning, ML, model, the at least one image at each time interval to predict a value of at least one manufacturing parameter associated with the manufacturing process; determine whether the predicted value of the at least one manufacturing parameter is within a predefined range of values; and generate instructions for corrective action when the predicted value is outside the predefined range of values.

The at least one processor may be further arranged to: transmit the generated instructions to the apparatus.

In some cases, the steps performed by the at least one processor may be performed in real-time, and the generated instructions may be transmitted while the manufacturing process is in progress.

The step to generate instructions for corrective action may comprise generating instructions to adjust a value of at least one manufacturing parameter. In this case, the at least one processor may be further arranged to: receive confirmation, from the apparatus, that the value of the at least one manufacturing parameter has been adjusted; and process at least one image using the trained machine learning, ML, model, that is received after the confirmation has been received.

Alternatively, the step to generate instructions for corrective action may comprise generating instructions to abort the current manufacturing process.

The steps performed by the at least one processor may be performed after a current iteration of the manufacturing process has ended, and the generated instructions may be transmitted before a subsequent iteration of the manufacturing process begins. In this case, the step to generate instructions for corrective action may comprise generating instructions to adjust a value of at least one manufacturing parameter of the subsequent iteration of the manufacturing process.

In a fourth approach of the present techniques, there is provided a computer-implemented method for training a machine learning, ML, model to enable closed-loop control of a manufacturing process, the method comprising: obtaining a training dataset comprising a plurality of images of the manufacturing process, wherein each image is labelled with a plurality of manufacturing parameters associated with the manufacturing process and a timestamp; training a machine learning, ML, model by: inputting images from the training dataset into the ML model; processing, using modules of the ML model, an input image to identify one of the manufacturing parameters; predicting, using modules of the ML model, a value of each manufacturing parameter for the input image; comparing the predicted values with the labels of the image; and updating the ML model to reduce a difference between the predicted values and the labels of the image.

In one example, the ML model may comprise attention modules/layers and masks, convolutional layers, dense layers, and skip connections. In this case, training the ML model may comprise: inputting images from the training dataset into the ML model (where the images may be individual images or frames, or videos comprising multiple frames); processing, using the ML model, an input image, in order to identify one of the manufacturing parameters; predicting, using the ML model, a value of each manufacturing parameter for the input image; comparing the predicted values with the labels of the image to generate a loss function; and using backpropagation to train the ML model to reduce the loss function. The processing step may comprise using the attention layers and masks, convolutional layers, skip connections and/or dense layers. Similarly, the predicting step may comprise using any or all of the layers. It will be understood this is just one example architecture of ML model, and other suitable architectures may be used.

The ML model may also be trained to generate corrective actions to correct errors at inference time. That is, at inference time, the ML model may not only identify that an error has occurred (i.e. that a manufacturing parameter is outside of a predefined range of acceptable values), but is able to generate instructions to correct the error, as explained above. The ML model may therefore be trained using expert-informed heuristics that indicate how the error could be corrected.

Transfer learning may be used to improve the accuracy of the ML model in detecting and correcting errors in a single part, or a family of similar parts. This may comprise using a pre-trained network to generate the ML model, and training the pre-trained network on data derived solely from manufacturing that one part or family of parts. Thus the training data used to train the pre-trained network may comprise images of a broad range of parts or objects, and/or a narrow range of parts (e.g. one part or a family of related/similar parts).

In a related approach of the present techniques, there is provided a non-transitory data carrier carrying processor control code to implement any of the methods, processes and techniques described herein.

As will be appreciated by one skilled in the art, the present techniques may be embodied as a system, method or computer program product. Accordingly, present techniques may take the form of an entirely hardware embodiment, an entirely software embodiment, or an embodiment combining software and hardware aspects.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object oriented programming languages and conventional procedural programming languages. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

Embodiments of the present techniques also provide a non-transitory data carrier carrying code which, when implemented on a processor, causes the processor to carry out any of the methods described herein.

The techniques further provide processor control code to implement the above-described methods, for example on a general purpose computer system or on a digital signal processor (DSP). The techniques also provide a carrier carrying processor control code to, when running, implement any of the above methods, in particular on a non-transitory data carrier. The code may be provided on a carrier such as a disk, a microprocessor, CD-or DVD-ROM, programmed memory such as non-volatile memory (e.g. Flash) or read-only memory (firmware), or on a data carrier such as an optical or electrical signal carrier. Code (and/or data) to implement embodiments of the techniques described herein may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog (RTM) or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

It will also be clear to one of skill in the art that all or part of a logical method according to embodiments of the present techniques may suitably be embodied in a logic apparatus comprising logic elements to perform the steps of the above-described methods, and that such logic elements may comprise components such as logic gates in, for example, a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In an embodiment, the present techniques may be implemented using multiple processors or control circuits. The present techniques may be adapted to run on, or integrated into, the operating system of an apparatus.

In an embodiment, the present techniques may be realised in the form of a data carrier having functional data thereon, said functional data comprising functional computer data structures to, when loaded into a computer system or network and operated upon thereby, enable said computer system to perform all the steps of the above-described method.

### BRIEF DESCRIPTION OF THE DRAWINGS

Implementations of the present techniques will now be described, by way of example only, with reference to the accompanying drawings, in which:

FIG. 1 shows a flowchart of example steps for closed-loop control of a manufacturing process;

FIG. 2 is a block diagram of a system for closed-loop control of a manufacturing process;

FIGS. 3A to 3F illustrate an overview of the CAXTON system used for automated data collection;

FIG. 4A shows an example architecture of a neural network used to perform the closed-loop control;

FIG. 4B shows confusion matrices of the final network for each parameter;

FIGS. 5A to 5D show the three stages of training a residual attention CNN with CAXTON's 3D printing parameter dataset;

FIGS. 6A to 6C show a machine vision control system pipeline and feedback parameters; and

FIGS. 7A to 7F show printer and feedstock agnostic online parameter correction and discovery.

### DETAILED DESCRIPTION OF THE DRAWINGS

Broadly speaking, embodiments of the present techniques provide a method, apparatus and system for automatically detecting and correcting errors in manufacturing parameters of a manufacturing processes using closed-loop control. Advantageously, the present techniques not only monitor manufacturing parameters but also provide instructions to enable any unacceptable variation in a manufacturing parameter to be corrected during the manufacturing process.

Errors are a frequent occurrence in additive manufacturing, AM, processes and major challenges with respect to reliability and consistency are yet to be solved. Presently, the extrusion printing process is open loop, and today's machines are unaware of the current printing state. This is a significant limitation due to the frequency of errors in the manufacturing process. Thus, a single part often requires multiple iterations to achieve a successful print, wasting valuable material, energy, and time. For each of these errors an experienced human operator is required to assess the cause of the errors and subsequently adjust the appropriate parameters.

Warping is one of the most prevalent error modalities, especially in high-performance and high-temperature materials which are more costly and used in production settings (e.g. PEEK, ULTEM). Warp deformation is caused by the contraction of extruded filament; this occurs because the deposition process involves a large temperature gradient causing residual thermal stresses to develop. Errors which are caused by the build-up of internal stresses in the printed part take time to appear and as such, it is hard to detect the errors quickly and determine their cause. Multiple factors impact the scale of warping in a print, such as model size, layer number, stacking section length, bed and chamber temperatures, and material linear shrink-rate.

Many different approaches have been developed to detect errors during or after printing. A wide range of sensors have been used for monitoring the process, for example acoustic, inertial, and current sensors. However, vision-based sensing technologies offer richer information and can identify a broader selection of error types. This is especially the case of long-term errors such as warping where the appearance of the error is offset from the time of material deposition. Contemporary work exists using both traditional computer vision and deep learning approaches to monitoring the printing process. The latter has the advantage of being more generalisable and robust to varying conditions compared to hand-crafted feature detectors. Furthermore, over the past decade various neural network architectures have revolutionised the field of pattern recognition. Deep convolutional neural networks have led to numerous breakthroughs in image classification and object detection. Specifically, object detection networks offer vast opportunities in automated monitoring of manufacturing as they are trained to detect and localize instances of features in images.

Deep learning techniques are particularly interesting for their potential to be far more generalisable to new materials and printers than hand crafted features. Such models are beginning to be applied to process monitoring for extrusion printers to enable real-time correction and demonstrate that deep learning methodologies can be effective at in-situ monitoring. For these systems to be deployed in the production environment they must work on a range of printers with varying camera positions and lighting conditions in addition to working for any 3D geometry printed out of materials of differing colours and properties. Finally, automated error detection and correction methods need to be scalable to enable easy deployment and to collect more data for further improving the deep learning model.

The present techniques provide a low-cost and scalable method to augment any manufacturing process, such as thermoplastic extrusion 3D printing, with state-of-the-art object detection models capable of detecting warp—a frequent error in filament based AM. The development of the method has also resulted in the curation of the first large scale labelled dataset of warping examples for a wide range of part geometries. With this dataset a single stage deep convolution neural network is trained to both detect and localize warp features in unseen images and provide a confidence level for its predictions. Unlike existing approaches for other error modalities, the approach presented here extracts further data from the image to provide an estimate concerning the severity of warping error present. This has been achieved through the development of a suite of statistically verified metrics, capable of determining the warp severity both during printing and upon print completion.

The present techniques provide an easily deployable method for augmenting a manufacturing process with a convolutional neural network (CNN) to create self-learning robotic printers, capable of online error detection and correction in addition to parameter discovery for new and unseen manufacturing materials. This has been realised through the development of a system named CAXTON: the collaborative autonomous extrusion network. CAXTON is a fully autonomous system for connecting and controlling learning 3D printers, in turn enabling fleet data collection and collaborative end-to-end learning. Each printer in the network can continuously print and collect data due to a novel part removal system. Specifically, CAXTON uses inexpensive cameras, deep learning algorithms, and an automated sample remover to autonomously learn how to accurately identify and correct errors at low computational cost. Unlike existing deep learning AM monitoring work, which often uses human labelling of errors to train algorithms, CAXTON labels errors in terms of deviation from optimal printing parameters. Uniquely, CAXTON thus knows not just how to identify but also to correct diverse errors because by looking at the image it knows how far printing parameters are from their optimum. This classification method also allows autonomous generation of training data, enabling larger and more diverse data sets for better accuracy, and generalisation to previously unseen manufacturing devices, camera positions, and materials. This research also advances the state of the art as the first work able to correct multiple parameters simultaneously and self-learning the interplay between the various parameters—making the system capable of devising multiple solutions to solve the same error. With this capability CAXTON can discover parameter combinations for unseen manufacturing material, using different manufacturing paradigms. Finally, visualisation methods were employed to gain insights into how the trained neural network performs—this transparency being vital for real-world and end use applications, especially in areas such as the production of medical devices.

With the data gathered using CAXTON, the first large scale, optical, in-situ process monitoring dataset has been curated, containing over 1 million sample images with their respective labelled printing parameters from 192 prints of different geometries. This dataset has enabled the training of deep residual attention models capable of detecting suboptimal printing parameters. With these trained models, the online correction of multiple printing parameters simultaneously for known thermoplastic feedstocks, or manufacturing materials, is demonstrated. This control loop removes the time-consuming constraints and reduces the occurrence of errors, in turn improving the efficiency of the 3D printing process. Furthermore, it is demonstrated that the system can self-learn parameter combinations to autonomously print unseen feedstocks with dramatically different properties on unknown setups. This takes the place of an expert human operator, unlocking a range of possibilities to print without human interaction. With optimisation, it is expected this approach will enable printers to become completely operator independent, able to detect and correct errors in real-time in addition to figuring out how best to manufacture devices.

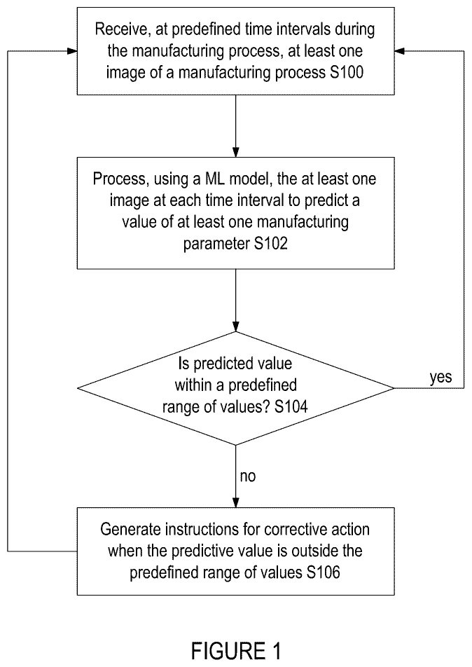

FIG. 1 shows a flowchart of example steps for closed loop control of a manufacturing process. The method may be performed by an apparatus (or components thereof) that is used to perform the manufacturing process. Alternatively, the method may be performed by a remote server which is remote to the apparatus that is used to perform the manufacturing process.

The method begins by receiving, at predefined time intervals during the manufacturing process, at least one image of the manufacturing process (step S100).

The step (S100) of receiving at least one image at predefined time intervals may comprise receiving at least one image at predefined time intervals of between one and ten seconds. In some cases, the at least one image may be received at predefined time intervals of less than a second. For example, an image sensor may be used to capture images at a rate of 30 frames per second (30 fps). It will be understood that these are example, non-limiting predefined time intervals, and any suitable time interval may be used.

It may be useful to receive the at least one image at predefined time intervals throughout a manufacturing process, such that the whole duration of the manufacturing process is monitored and controlled. However, often, when an error (i.e. a deviation of at least one manufacturing parameter) occurs at the beginning of a manufacturing process, it may adversely affect the rest of the process if it is not corrected or correctable. Thus, it may be useful to monitor the beginning of (i.e. an initial part of) a manufacturing process because if an error occurs at this stage, it may be more efficient to correct the at least one parameter or to abort the process, in terms of cost, time, energy and materials. Therefore, receiving at least one image at predefined time intervals may comprise receiving at least one image at predefined time intervals during at least an initial part of the manufacturing process.

The method comprises processing, using a trained machine learning, ML, model, the at least one image at each time interval to predict a value of at least one manufacturing parameter associated with the manufacturing process (step S102). Step S102 may comprise processing the at least one image using a classification module of the trained ML model to predict a value of the at least one manufacturing parameter.

The method comprises determining whether the predicted value of the at least one manufacturing parameter is within a predefined range of values (step S104).

If at step S104 it is determined that the predicted value is within the predefined range of values, the method returns to step S100.

If at step S104 it is determined that the predicted value is not within the predefined range of values for that parameter, then the method comprises generating instructions for corrective action when the predicted value is outside the predefined range of values (step S106).

The step (S106) of generating instructions for corrective action may comprise generating instructions to adjust a value of at least one manufacturing parameter. This may be useful when, despite the at least one manufacturing parameter having deviated outside of the predefined range of acceptable values, the manufacturing process has not been adversely affected yet. For example, when the manufacturing process involves 3D printing an object, if the object has not been adversely affected or damaged by the deviation of the at least one manufacturing parameter, then it may be useful to correct/adjust the parameter(s) and continue 3D printing the object. In this case, the method may comprise: receiving confirmation that the value of the at least one manufacturing parameter has been adjusted; and processing at least one image using the trained machine learning, ML, model, that is received after the confirmation has been received.

Alternatively, the step (S106) of generating instructions for corrective action may comprise generating instructions to abort the current manufacturing process. This may be useful when the deviation of the at least one manufacturing parameter outside of the predefined range of acceptable values causes the manufacturing process to be adversely affected. For example, when the manufacturing process involves 3D printing an object, when the object has been adversely affected or damaged by the deviation of the at least one manufacturing parameter, then it may not be useful to continue 3D printing the object. Instead, it may be efficient to stop 3D printing the object, in terms of cost, time, energy and materials. The manufacturing process may be restarted from the beginning.

In some cases, the method shown in FIG. 1 may be performed in real-time, to enable real-time control of the manufacturing process. In these cases, the corrective action is performed in real-time or near real-time with respect to a current iteration of the manufacturing process. This may be possible if the trained machine learning model is, for example, part of or local to an apparatus used to perform the manufacturing process.

Alternatively, the method of FIG. 1 may be performed after a current iteration of the manufacturing process has ended, to enable control of a subsequent iteration of the manufacturing process. Performing the method after a current iteration of the manufacturing process has ended means that the whole manufacturing process can be analysed and instructions for corrective action may be issued for a subsequent iteration of the manufacturing process. The error detection process can also be applied as a means for quality control means after the manufacturing process has finished. This could be especially useful in the production of, for example medical devices.

In the case that the method is not performed in real-time, the corrective action is performed with respect to the subsequent iteration of the manufacturing process. This may useful if the trained machine learning model is, for example, not part of or local to an apparatus used to perform the manufacturing process. For instance, if the trained ML model is remote to the apparatus (e.g. located on a remote or cloud server), the time to transmit the images to the remote server, and the time to transmit the instructions for corrective action back to the apparatus may be too long for the manufacturing process to be effectively controlled in real-time or near real-time. As such, it may be more useful to use the information received for one iteration of the manufacturing process to control another, subsequent, iteration. This may also be useful when the corrective action is to abort the current iteration of the manufacturing process. In another example, an error in at least one manufacturing parameter may build over time (e.g. during an iteration of the manufacturing process), and/or the parameter may not be correctable in real-time. For example, errors such as cracking and warp deformation, where stresses in the object being manufactured build over time, cannot be corrected in real-time. In this case, corrective action can only be taken with respect to the subsequent iteration of the manufacturing process

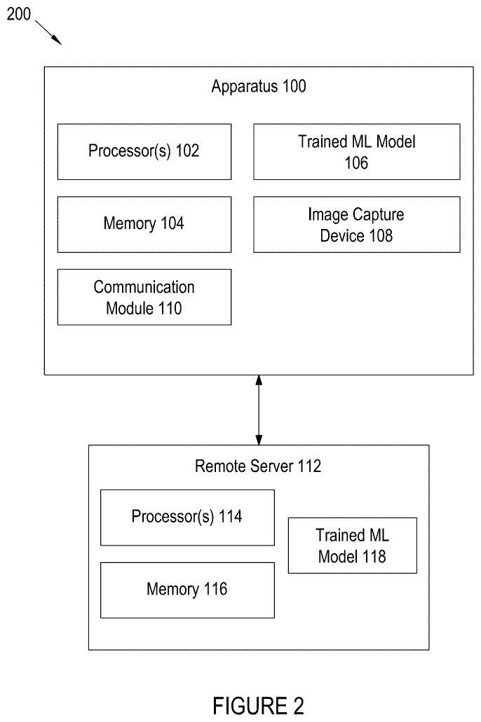

FIG. 2 is a block diagram of a system 200 and apparatus 100 for closed-loop control of a manufacturing process.

The apparatus 100 is for performing a manufacturing process using closed-loop control. The apparatus comprises at least one processor 102 coupled to memory 104. The at least one processor 102 may comprise one or more of: a microprocessor, a microcontroller, and an integrated circuit. The memory 104 may comprise volatile memory, such as random access memory (RAM), for use as temporary memory, and/or non-volatile memory such as Flash, read only memory (ROM), or electrically erasable programmable ROM (EEPROM), for storing data, programs, or instructions, for example.

The apparatus 100 may comprise a trained machine learning, ML, model 106.

The processor 102 is arranged to: receive, at predefined time intervals during the manufacturing process, at least one image of the manufacturing process; process, using a trained machine learning, ML, model, the at least one image at each time interval to predict a value of at least one manufacturing parameter associated with the manufacturing process; determine whether the predicted value of the at least one manufacturing parameter is within a predefined range of values; and generate instructions for corrective action when the predicted value is outside the predefined range of values.

The apparatus 100 may further comprise at least one image capture device 108 for capturing the at least one image of the manufacturing process at predefined time intervals. The image capture device 108 may be any one of: a camera; an optical sensor; and an infra-red sensor or camera.

The apparatus 100 may be any one of: an extrusion-based 3D printer; an additive manufacturing apparatus; a material extrusion apparatus; a stereolithography apparatus; a laser powder bed fusion apparatus; a milling apparatus; a turning apparatus; a lathe; a laser cutter; and a plasma cutter. It will be understood that this is a non-exhaustive list of possible apparatus.

As mentioned above, the present techniques may be performed in real-time, to enable real-time control of the manufacturing process. In these cases, the corrective action is performed in real-time or near real-time with respect to a current iteration of the manufacturing process. This may be possible if the trained machine learning model 106 is, for example, part of or local to an apparatus 100 used to perform the manufacturing process.

Alternatively, as mentioned above, the method may be performed after a current iteration of the manufacturing process has ended, to enable control of a subsequent iteration of the manufacturing process. In these cases, the corrective action is performed with respect to the subsequent iteration of the manufacturing process. This may useful if the trained machine learning model is, for example, not part of or local to an apparatus 100 used to perform the manufacturing process. In this case, the trained machine learning model may not be part of or stored on the apparatus 100. Instead, the apparatus 100 may transmit data to a trained machine learning model that is located remote to the apparatus 100.

Thus, the apparatus 100 may comprise a communication module 110 for transmitting the at least one image for processing.

The system 200 may comprise a remote server 112. The remote server 112 may comprise at least one processor 114 coupled to memory 116. The remote server 112 may comprise a trained ML model 118. The at least one processor 114 may be arranged to: receive the at least one image of the manufacturing process from the apparatus 100; process, using a trained machine learning, ML, model 118, the at least one image at each time interval to predict a value of at least one manufacturing parameter associated with the manufacturing process; determine whether the predicted value of the at least one manufacturing parameter is within a predefined range of values; and generate instructions for corrective action when the predicted value is outside the predefined range of values.

The at least one processor 114 may be further arranged to: transmit the generated instructions to the apparatus 100.

In some cases, the steps performed by the at least one processor 114 may be performed in real-time, and the generated instructions may be transmitted while the manufacturing process is in progress.

The step to generate instructions for corrective action may comprise generating instructions to adjust a value of at least one manufacturing parameter. In this case, the at least one processor 114 may be further arranged to: receive confirmation, from the apparatus 100, that the value of the at least one manufacturing parameter has been adjusted; and process at least one image using the trained machine learning, ML, model 118, that is received after the confirmation has been received.

Alternatively, the step to generate instructions for corrective action may comprise generating instructions to abort the current manufacturing process.

The steps performed by the at least one processor 114 may be performed after a current iteration of the manufacturing process has ended, and the generated instructions may be transmitted before a subsequent iteration of the manufacturing process begins. In this case, the step to generate instructions for corrective action may comprise generating instructions to adjust a value of at least one manufacturing parameter of the subsequent iteration of the manufacturing process.

The present techniques are now explained with reference to a specific type of manufacturing process: extrusion-based 3D printing. It will be understood that the following illustrates how the present techniques may be used, but that this is a non-limiting example.

Furthermore, four manufacturing parameters are considered in this example, but it will be understood that these are non-exhaustive and non-limiting parameters.

### Dataset Generation, Filtering, and Augmentation

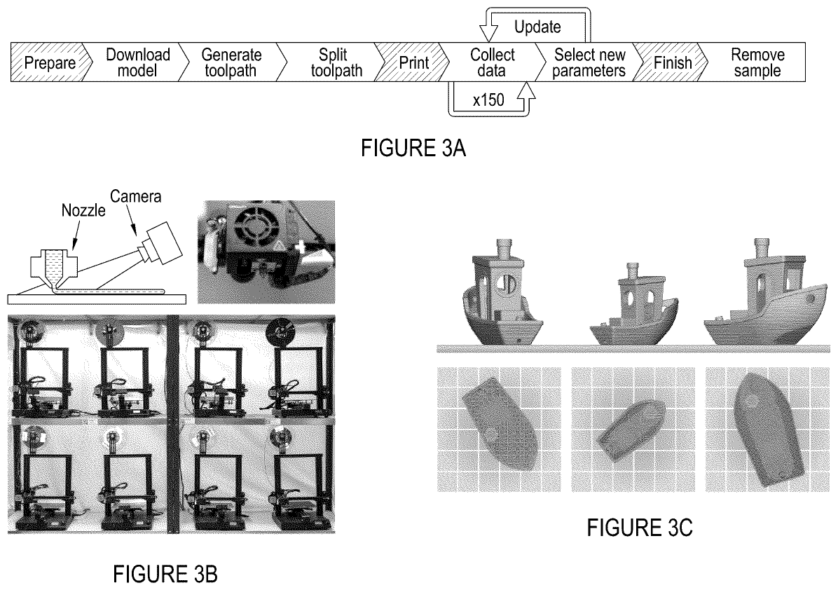

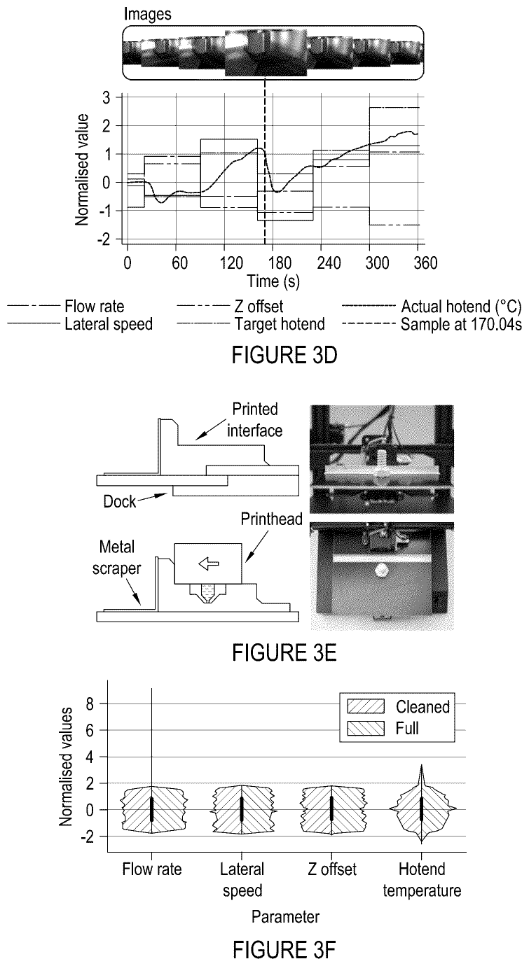

FIGS. 3A to 3F illustrate an overview of the CAXTON system used for automated data collection.

A network of 8 FFF 3D printers were used for data collection. Creality CR-20 Pro printers were chosen due to their low-cost, pre-installed bootloader and included Z probe. The firmware for each printer was flashed to Marlin 1.1.9 to ensure thermal runaway protection was enabled, which is crucial for leaving the printers unattended. In the standard firmware configuration process EEPROM chit chat was enabled as well as new axis limits for the bed remover. Each printer was equipped then with a Raspberry Pi 4 Model B acting as the networked gateway for sending/receiving data to/from the printer via serial. The Pi is running a Raspbian based distribution of Linux and an OctoPrint server with a custom developed plugin. A low-cost, consumer USB webcam (Logitech C270) was connected to the Pi for taking snapshots. The camera was mounted facing the nozzle tip using a single 3D printed part. These components can easily be fitted to new and existing printers for minimal cost; as such, the authors believe that it is the first truly scalable and deployable system of its kind.

The printer used for direct ink writing was a modified Creality Ender 3 Pro. The extruder setup was designed and built in-house and utilised a stepper motor driven syringe with luer lock nozzle. The printer is equipped with a Pi, Z probe and Raspberry Pi Camera v1 with zoom lens. The firmware is a modified version of Marlin 2.0.

FIG. 3A shows a workflow for collecting varied data with automatic labelling of images with 3D printing parameters. A new 3D printing dataset containing parts printed using polylactic acid (PLA) was generated, labelled with their associated printing parameters, for a wide range of geometries and colours on a fleet of extrusion-based 3D printers. The data generation pipeline disclosed in the present application automates the entire process from STL file selection to toolpath planning, data collection and storage (see FIG. 3A). Model geometries were automatically downloaded at random from the online repository, Thingiverse.

FIG. 3B shows how images are captured using a fleet of 8 FFF 3D printers equipped with image capture devices (e.g. cameras) focused on the nozzle tip to monitor extrusion. During printing, images are captured every 0.4 seconds. Each captured image is timestamped and labelled with the current printing parameters: actual and target temperatures for the hotend and bed, flow rate, lateral speed, and Z offset. Additionally, for each image nozzle tip coordinates on each printer are saved to allow for easy cropping around the region of interest during training.

FIG. 3C shows the rendering of generated toolpaths for a single input geometry, with randomly selected slicing parameters.

FIG. 3D shows a snapshot of data gathered during a print showing images with varying parameter combinations. After 150 images have been collected, a new combination of printing parameters is generated for every printer by sampling uniform distributions of each parameter. The new parameter combinations are sent to each printer over the network as gcode commands which are subsequently executed. Upon execution another 150 labelled images are gathered before the parameter update process happens again. This continues until the end of the print, and results in sets of images each with vastly different printing parameters (see FIG. 3D).

So that the printers can operate continuously without human intervention, a new and simple method for removing completed prints has been developed. Numerous methods have previously been implemented to automatically remove parts upon completion; however, previous implementations either require extensive hardware modification, are costly, or only able to remove a relatively limited range of parts. FIG. 3E shows a design of a bed remover and dock utilising existing motion system with photographs taken during operation. Here a new simple and effective bed removal system is proposed requiring no additional electronics, motors, or complex mechanical parts. The proposed solution can be retrofitted to any extrusion printer and is composed primarily of printed parts which can be produced by the printer in question. The already mobile printhead moves and docks with a scraper located to the rear of the build platform. Subsequently, the printer's inbuilt motors are used to move the printhead and scraper across the build surface removing the printed object. After removal, the printhead returns the scraper to its home location and undocks. To ensure that the scraper always remains in the same position, a scraper-dock with magnets is attached to the print bed to hold the scraper in place until the next object requires removal.

FIG. 3F shows the distributions of normalised parameters in the full dataset collected by CAXTON containing over 1.2 million samples. Due to sampling suboptimal parameter combinations, some prints turn into complete failures, which after a certain point provides little information on the associated parameters. Such images are manually removed, leaving 1,166,552 labelled images (91.7% of the original 1,272,273). The remaining dataset contains some noisy labels due to the longer response times in updating printing parameters, such as flow rate, before a noticeable change is present in the image. The response time consists of a command execution delay and mechanical delay. The first delay is mostly handled by only capturing images after an acknowledgement of the parameter update command has been received from the printer. For mechanical delay, worst case experiments were run to determine the response time for changing each parameter from the minimum to the maximum value in the dataset. It was found that changes were predominantly visible within 6 seconds of an update being applied, and as such 15 images are removed post parameter updates. This leaves 1,072,500 samples where the system has reached its desired state. Unrealistic parameter outliers caused by printers not properly executing the gcode commands or glitches in sensors such as thermistors were filtered, leaving 991,103 samples. Finally, very dark images with a mean pixel value across RGB channels of less than 10 are removed. This results in a cleaned dataset of 946,283 labelled images (74.4% of the original). The currently continuous parameter values are then binned into three categories for each parameter: low, good, and high. The upper and lower limits for these bins are selected from experience. This creates a possible 81 different class combinations for the network to predict (3 categories for 4 parameters).

In deep learning large datasets are preferred to avoid overfitting and to achieve a high level of generalisability; thus, data augmentation is used to further enhance the size and quality of the filtered dataset, which in turn improves the performance of trained models. The locality and shape of the deposited material in the captured images varies greatly depending upon the printed model's geometry. Additionally, it was found that colour, reflectance, and shadows all differed with camera position, material choice and printer mechanics. As such, to increase the size of the dataset each image was subjected to a wide range of data augmentation techniques to simulate a wider variety of geometries, camera locations and materials. First, the full-sized image captured by the camera is randomly rotated by up to 10 degrees in either direction. Then a minor perspective transform is applied with a probability of 0.1. The next step is to crop the image to a 320×320 pixel square region focused on the nozzle tip using the coordinates saved during data collection. The rotation and perspective transforms are applied before the crop to practically remove the need of padding in the cropped region. A random square portion with an area between 0.9-1.0 of the 320×320 image is then cropped and resized to 224×224 pixels-the input size for the deep neural network. Subsequently, a horizontal flip can be applied to the image with a probability of 0.5 followed by jitter of +/−10% to the image's brightness, contrast, hue, and saturation. Finally, the channels in the transformed image are normalised using each channel's pixel mean and standard deviation for all the images in the filtered dataset.

### Model Architecture, Training, and Performance

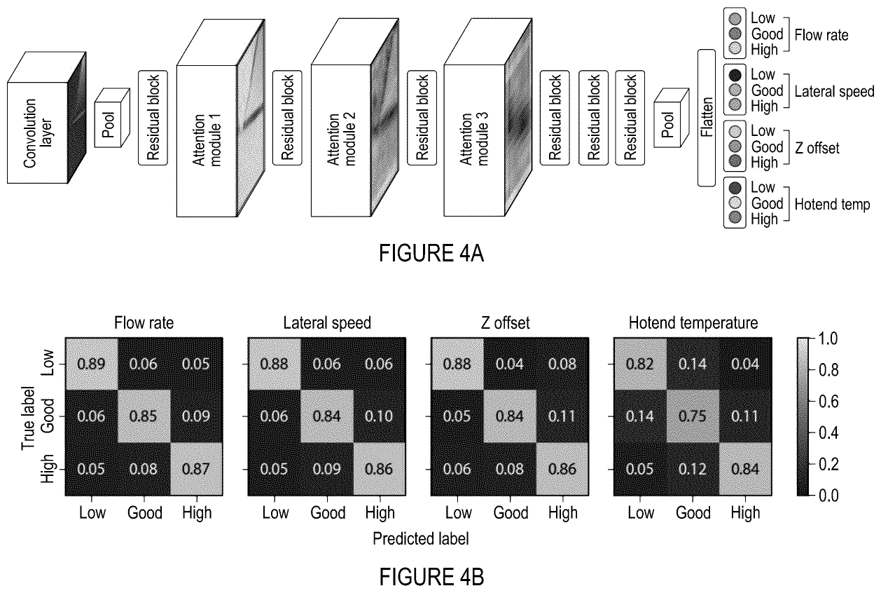

FIG. 4A shows an example architecture of a neural network used to perform the closed- loop control of the present techniques. In this case, the architecture comprises attention modules and residual blocks with a separate fully connected output branch for each parameter. Attention modules consist of a trunk branch containing residual blocks and a mask branch which performs down-and up-sampling. It will be understood that other suitable architectures may be used to perform the closed-loop control described herein. For example, the neural network may comprise convolutional layers (and may be based on e.g. ResNet, EfficientNet, RegNet, or ConvNext), and/or transformers (e.g. ViT or BiT). More generally, as mentioned above, the neural network may comprise any or all of: convolutional layers, skip connections, attention layers and masks, and dense layers.

The accurate prediction of current printing parameters in the extrusion process from an input image is achieved using the residual attention network of FIG. 4A with a single backbone and four head output branches, one for each parameter. The use of attention reduces the number of network parameters needed to achieve the same performance in standard image classification datasets whilst making the network more robust to noisy labels. Furthermore, the attention maps in the network enable a certain level of transparency, helping detect errors and explain predictions. The shared backbone allows for feature extraction to be shared for each parameter and as such reduces inference time compared to having separate networks. Additionally, it allows the network to model the interplay between different parameters. Each branch has three output neurons for classifying a parameter as low, good, or high. With this structure, the network predicts the state of the flow rate, lateral speed, Z offset and hotend temperature simultaneously from a single RGB input image. This would be exceptionally challenging for an expert human operator; nevertheless, the final trained classifies the states of all these parameters in our varied test set, achieving a high classification accuracy of 84.3% (meaned across the four parameters). This is especially difficult as many of the parameters are dependent on each other—having a higher Z offset with the nozzle far from bed can easily be mistaken as having a low flow rate and under extruding. As such accuracy is not the perfect metric for determining the effectiveness of the network as in real-world deployment multiple different combinations of actions can lead to good extrusion. For each parameter the following classification accuracies were obtained on the test set: flow rate 87.1%, lateral speed 86.4%, Z offset 85.5% and hotend temperature 78.3%.

The network primarily consists of 3 attention modules and 6 residual blocks and is based on the Attention-56 network. The attention modules are composed of two branches: the mask and the trunk. The trunk branch performs the feature processing of a traditional network and is constructed from residual blocks. The mask branch undertakes down-sampling followed by up-sampling to learn an attention mask with which to weight the output features of the module. This mask can not only be used during the forward pass for inference, but also as a mask in the backward pass during back propagation. This was one of the reasons for choosing this network architecture as mask branches can make the network more robust to noisy labels—which the dataset contains due to parameter changes and subtle inconsistencies during printing. After these blocks, the network is flattened to a fully connected layer which links to each of the separate 4 branches. The branches need to be separate outputs of the network as each prediction requires each branch to have a single prediction.

FIG. 4B shows confusion matrices of the final network for each parameter in the test dataset, i.e. flow rate, lateral speed, Z offset and hotend temperature.

The ML model may be trained using a single stage or N stages. For the particular architecture described above, it was found that splitting the training process into three separate stages was most robust. This example training method is described below, but it will be understood that this is merely exemplary and other suitable training methods may be used with this architecture or different architectures.

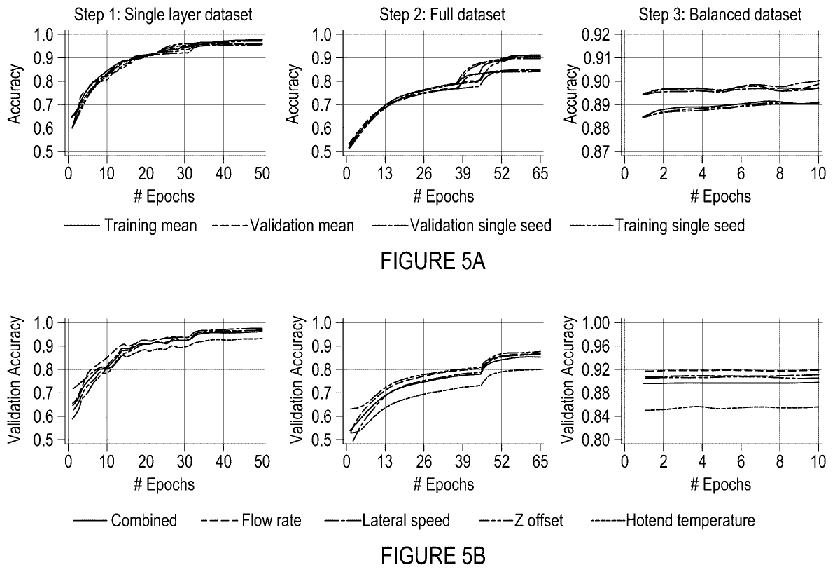

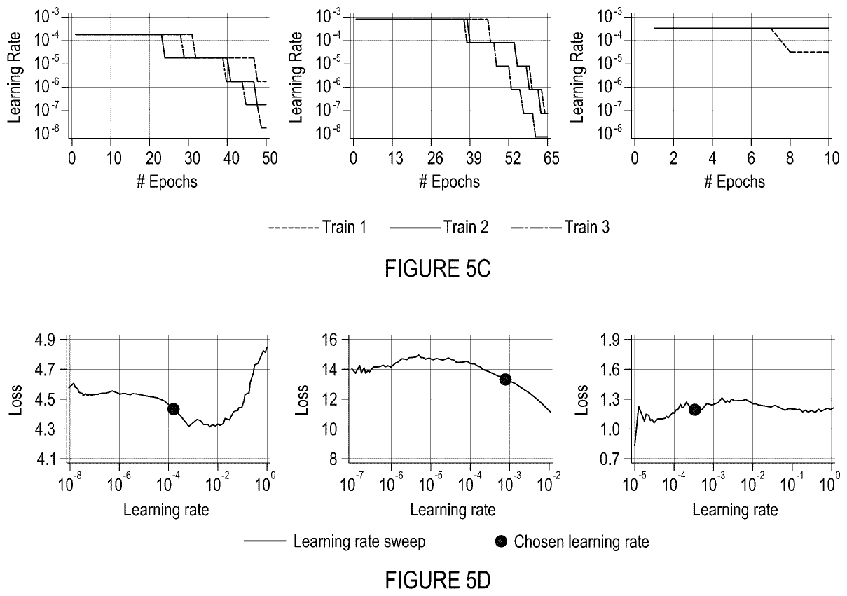

FIGS. 5A to 5D show the three stages of training a residual attention CNN with CAXTON's 3D printing parameter dataset. FIG. 5A shows training and validation accuracy plots for training the network across three seeds, smoothed with an exponential moving average, on three datasets: single layer, full, and balanced. FIG. 5B shows validation accuracy plots for each parameter and their combined mean for the best of three seeds, smoothed with an exponential moving average. FIG. 5C shows learning rate decay for each train across three seeds using a reduce on plateau learning rate scheduler. Learning rate reduction results in noticeable increase in accuracy at certain points in FIGS. 5A and 5B. FIG. 5D shows initial learning rate for each training stage which was chosen by sweeping a wide learning rate range and selecting a value with a steep drop in loss.

For each stage differently seeded networks were trained. In the first stage, the network is trained on a sub-dataset containing only images of first layers with 100% infill. The features are more visible for each parameter in these prints and by first training with this subset the network can more quickly learn to detect important features. It was found that this separation sped up the learning process as features were more learnable for the single layer and could subsequently be tuned on the full dataset making the network generalisable to complex 3D geometries. A training accuracy of 98.1% and validation accuracy of 96.6% was achieved by the best seed. A transfer learning approach was then used to retrain the model of the best seed on the full dataset containing images for all 3D geometries. This was done 3 times with the best seed achieving a training and validation accuracy of 91.1% and 85.4% respectively. Networks can learn inherent biases in the data given to them; therefore, due to imbalances in the full dataset (for example the Z offset can have many more values which are too high than too low because the nozzle would crash into the printbed) transfer learning was again used. This time however, only the final fully connected layer to each of the 4 branches was trained on a balanced sub-dataset containing an equal number of samples for each of the possible 81 combinations (4 parameters each of which can be low, good, or high). The rest of the network weights frozen. This achieved a training accuracy of 89.2% and validation accuracy of 90.2%.

The final trained network was tested on the test set which consists of random samples from the full geometry dataset where it achieves an accuracy of 84.3%.

To train the network the cross-entropy loss at each of the branches was determined and then these losses were summed together before back propagation. This results in “shared” regions of the network being updated to accommodate for each branch with the connections to the branch only being updated by its own loss. The initial learning rate was selected at each of the 3 training stages by sweeping a large range of values and selecting a learning rate with a large drop in loss. Learning rates for each of the stages can be seen in FIG. 5D. Selection of the correct learning rate was of key importance—a high learning rate led to poor attention maps whereas too low learning rates took longer to train or got stuck in early local minima. An AdamW optimiser was used during training with a reduce on plateau learning rate scheduler to decrease the learning rate by a factor of 10 when 3 epochs in a row didn't improve the loss by more than a 1%. Plots of the learning rate during training can be found in FIG. 5C. A training, validation, and test split of 0.7, 0.2 and 0.1 respectively was used with a batch size of 32. The 3 stages of training were trained for 50, 65 and 10 epochs respectively. Each stage was trained 3 times with 3 different seeds. During the transfer learning the best seed from the previous stage was chosen as the base to continue training from.

To visualise which features the network is focussing on at each stage, images of the attention maps after each module were created as seen in FIG. 5B. Here the same attention mask from each module is applied to each of the 3 input images with the areas not of interest darkened (note: these masks are illustrative examples as each module contains many different attention maps). The network clearly focuses on the printed regions in the example mask output for attention module 1, and then only the most recent extrusion for module 2. Module 3 applies the inverse to the previous focusing on everything but the nozzle tip. Gradient-weighted Class Activation Mapping (Grad-CAM) is also used to provide visual explanations, this can be thought of as post-hoc attention. It was found that the network to predominantly focus on the most recent extrusion from the nozzle for all parameter combinations. This is good, as for fast response times and corrections, it is desirable for the network to use the most recently deposited materials for its prediction.

### Online Correction and Parameter Discovery Pipeline

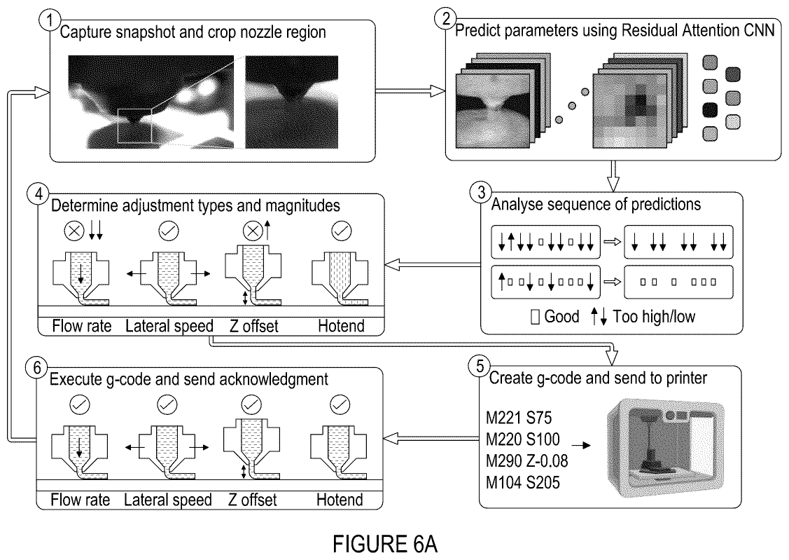

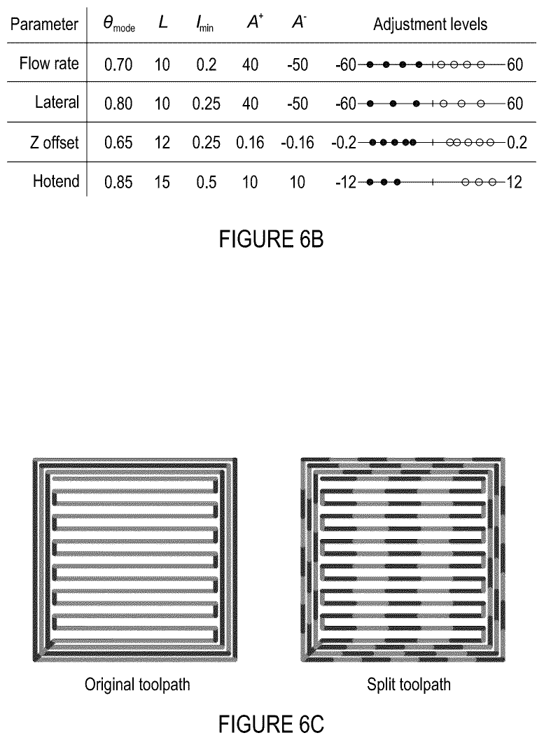

FIGS. 6A to 6C show a machine vision control system pipeline and feedback parameters. It will be understood that these Figures illustrate an example pipeline and example feedback parameters. The feedback parameters and their values can vary and be tuned, depending on the manufacturing process being controlled.

FIG. 6A shows the six major steps in the feedback pipeline enabling online parameter updates from images of the extrusion process. FIG. 6B shows a table containing θmode (mode threshold), L (sequence length), Imin (interpolation minimum), A+ (largest increase), A− (largest decrease) for each printing parameter along with the possible levels of update amounts. FIG. 6C shows a simple example single layer geometry illustrating toolpath splitting into equal smaller segments. Lengths of 0.5 mm are used in the feedback process to enable rapid correction; however, this dramatically increases the gcode file size.

Once downloaded, each 3D model was sliced with different settings for scale, rotation, infill density, number of perimeters and number of solid layers by randomly sampling from uniform distributions with the infill pattern chosen from a given list of common patterns. The generated set of toolpaths are subsequently converted to have maximum moves of 2.5 mm using a custom script to enable faster response times for parameter changes during printing. During the printing process images of nozzle tip and material deposition are taken at 2.5 Hz and sent to a local server for inference. Each received image is cropped to a 320×320 pixel region focused on the nozzle tip. The user needs to specify the pixel coordinates of the nozzle when mounting the camera once at setup. Furthermore, users may want to alter the size of the cropped region depending on the camera position, focal length, and size of printer nozzle. Choosing a suitable region around the nozzle affects the performance of the network and best balance between accuracy and response time is seen when approximately 5 extrusion widths are visible on either side of the nozzle tip.

The cropped image is then resized to 224×224 pixels and normalised across RGB channels. Next, the classification network produces a prediction for each parameter given this image as input. These predicted parameters are stored in separate lists of different set lengths, L, for each parameter; the lengths of these lists were important variables to tune to balance response time with accuracy (see FIG. 6B). The lengths of these lists were determined by doing experiments for each parameter in isolation with the same printing conditions. Large list lengths result in more accurate predictions, but a slow response time with the opposite true for small list lengths.

When a list is full, a mode threshold, θmode, is used to determine the resultant prediction. This threshold value is another variable tuned for each parameter by doing experiments for each parameter. If no mode is found, then no updates are made, and the printing parameter is treated as being “okay”. If a mode is found, then the size of the mode (proportion of the list length) is used to scale the response.

The proportion of the mode was used to scale the amount with which to update the given parameter. However, as the mode proportion is greater than the threshold, there is little room for feedback amount adjustment. As such, one-dimensional linear interpolation is applied to rescale the mode proportion to a wider range. This interpolation maps the range between a parameter threshold and 1 to a new minimum, Imin, tuned for each parameter and 1. This interpolation minimum value for each parameter is another variable that has been tuned with individual experiments. The interpolated proportion is then used as a scale factor to adjust the update amount—both increase, A+, and decrease, A−—for each parameter. The max positive and negative update amounts are more variables which are tuned for each printing parameter. The final values for all these variables can be seen in FIG. 6B—these values were obtained iteratively via experimentation for each parameter individually.

Once the final update amounts have been calculated for the printing parameters, they are sent to the Raspberry Pi attached to each printer. The Pi retrieves the current value for each parameter and then creates the desired gcode command to update the parameter to the new value using the received update amounts. The Pi then looks for acknowledgement of the command's execution by the firmware over serial. Once all commands have been executed by the firmware, the Pi sends an acknowledgement to the server. When the server receives acknowledgement that all updates have been executed it begins to make predictions again. Waiting for this acknowledgement of all parameter updates is crucial to stop oscillations caused by over and undershooting the target—making predictions is only desirable after the update has been applied.

To prove the efficacy of the system at correcting the printing parameters each was tested individually. The same model of printer was used as in training but with an altered camera position, a different 0.4 mm nozzle and unseen single layer printing sample. To compare the responses between parameters the same printer and conditions were used for each experiment, and each was printed using the same spool of PLA filament (PLA was the material used for all the training data).

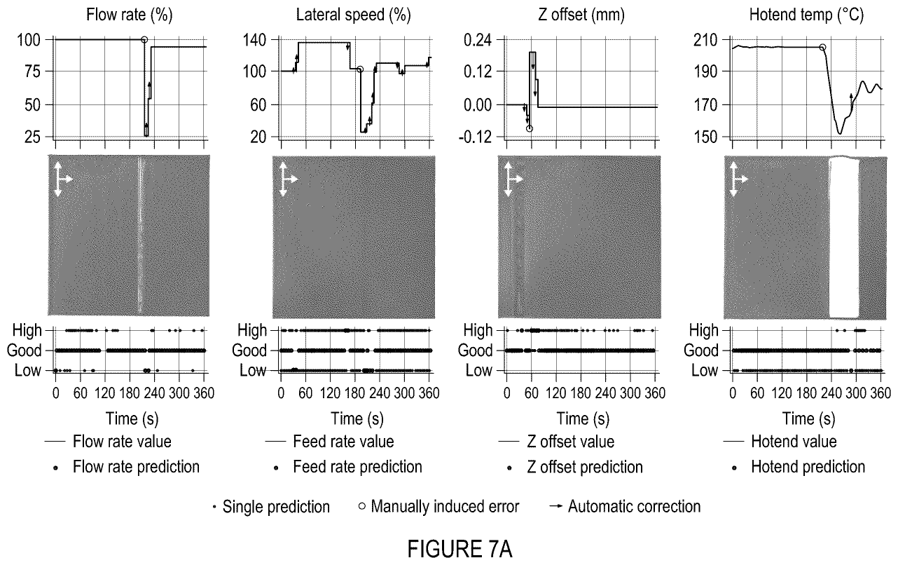

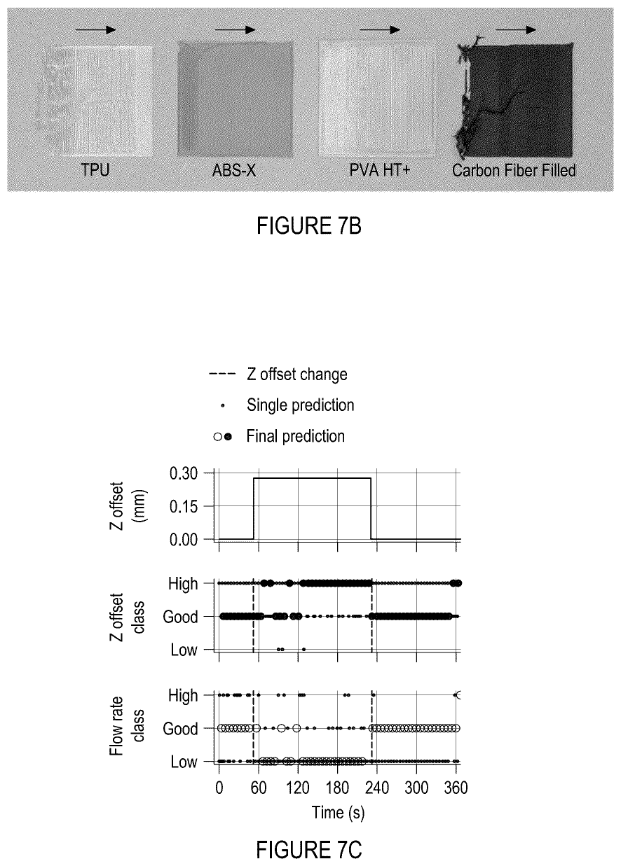

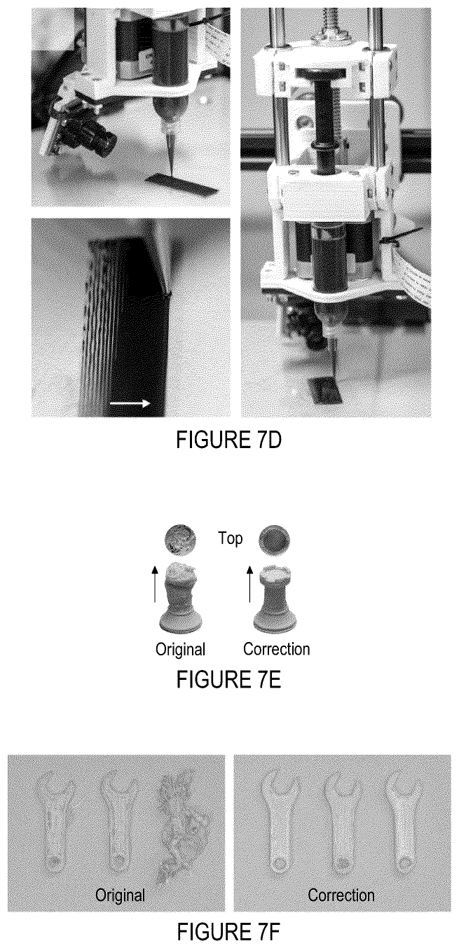

FIGS. 7A to 7F show printer and feedstock agnostic online parameter correction and discovery. FIG. 7A shows rapid in-situ correction of a manually induced erroneous single parameter using a single trained Residual Attention CNN model, printed with PLA feedstock on a known printer with unseen nozzle not used in training data. FIG. 7B shows online simultaneous optimization of multiple incorrect parameters on unseen thermoplastics, and demonstrates that the control pipeline is robust to a wide range of feedstocks with different material properties, colour, and initial conditions. FIG. 7C shows that, much like a human operator, the system uses self-learned parameter relationships for corrective predictions. A high Z offset can be fixed by both reducing the Z offset and/or by increasing material flow rate. FIG. 7D shows setup transfers to other extrusion processes, such as direct ink writing of PDMS on entirely unseen hardware (camera, printer, nozzle, extrusion process, material etc.). FIG. 7E shows correction of multiple incorrect printing parameters introduced mid print. Both rooks were printed in the same conditions with the only difference being correction. FIG. 7F shows correction of prints started with incorrect parameter combinations. All six spanners were printed in the same conditions.

Manually induced errors for each parameter were added to the files and the response of the control loop was recorded. An experimentation pipeline was constructed to take an input STL file, slice it with sensible print settings, insert a gcode command to alter a parameter to a poor value and then parse the generated gcode and split the model into 1.0 mm sections. Splitting the gcode reduces the firmware response time which can be lengthy. It was found that 1.0 mm enabled rapid correction whilst keeping gcode file sizes manageable. Attempting correction without toolpath splitting was incredibly slow for certain geometries, especially those with long moves. Splitting gcode files into chunks smaller than 1.0 mm limited the printing speed and resulted in jitters. This was caused by the printer not being able to read and process the gcode lines fast enough. FIG. 7A demonstrates corrections for each of the parameters with the parameter over time shown, along with the printed part and the predictions. The effects of the manually induced poor printing parameter can be easily seen for flow rate, Z offset and the hotend. For the lateral speed, upon close inspection a darker line can be seen only located around the slower print speed. Notice the small delay from the command being sent to the print shown by the black arrows and the parameter updating in value. This shows the importance in waiting for acknowledgements along with the benefits of toolpath splitting. The prediction plots demonstrate how effective the network after mode thresholding is at predicting the correct printing state. The hotend response time is noticeably longer than the other printing parameters due to the time taken to cool down and heat up along with requiring a longer list of predictions and higher mode threshold for safety reasons—a temperature increase of the hotend should therefore only be implemented if it is reasonably certain that this is required.

The control pipeline generalises to unseen thermoplastic feedstocks in a variety of colours with a wide range of different material properties. FIG. 7B shows online correction of multiple parameters for 4 different thermoplastics. Each of these samples were started with different combinations of multiple incorrect printing parameters. The TPU and carbon fibre filled samples have no printed perimeter due to poor initial conditions. However, for each the network successfully updates multiple parameters resulting in good extrusion. Not only is this useful for automated parameter discovery, aiding users in tuning their printers for new materials by quickly obtaining the best parameter combinations, but also it shows that control systems can improve productivity by saving failing prints where the initial toolpaths fail to adhere to the bed. Thanks to having all parameter predictions in one network structure, the trained model learns the interactions between multiple parameters and can offer creative solutions to incorrect parameters much in the same way as a human operator would. A sample was printed using the control loop setup but without making online corrections. This sample contained a region with a high Z offset. A high Z offset results in unjoin paths of extruded material—the same result can occur from under extrusion. FIG. 7C shows that the network determines that increasing the flow rate along with lowering the Z will result in good extrusion. As the trained model can find multiple ways to solve the same problem, it is possible to be more robust to incorrect predictions for a single parameter and enable faster feedback by combining updates across multiple parameters. The prediction plots also show the speed at which the network notices that parameters are now good—this is vital to ensure the control system does not overshoot when making online corrections.

To further test the developed control pipeline to its limits, it was tested it on a different printer modified for the direct ink writing of PDMS. The direct ink writing system uses a stepper motor with threaded rod to move a plunger in a syringe. A different model of a camera, mounted in a different position, with a transparent and reflective print bed made of glass was also used. The nozzle size of the direct ink writing system was also different at 0.24 mm. Only the flow rate was adjusted for this test with the PDMS printed at room temperature. FIG. 7D shows that the network learns to increase flow rate to increase the pressure for printing the material. It was found that once a set pressure was reached the correction of flow rate in one direction would stop. Sometimes during long prints, the control loop was found to overshoot flow rate due to large build of pressure in the syringe when correction of flow was not stopped fast enough. However, this problem is specific to the combination of syringe, small diameter nozzle and material choice. When printing other materials this overshoot and pressure delay became less of a problem. All the correction of parameters so far on single layer geometry has been done on the final network trained on 3D geometry. As such the network also works on full 3D models—the single layer geometries were chosen to show the correction of each parameter easily and visibly. In FIG. 7E the control pipeline was used on a range of full 3D geometries to demonstrate the methodology can be used in a production setting. Each of these prints was started with incorrect parameter combinations.

Different network structures could be applied to the collected dataset to improve the control loop's performance, provide quality control metrics, perform fast error detection, or even predict mechanical performance.

Those skilled in the art will appreciate that while the foregoing has described what is considered to be the best mode and where appropriate other modes of performing present techniques, the present techniques should not be limited to the specific configurations and methods disclosed in this description of the preferred embodiment. Those skilled in the art will recognise that present techniques have a broad range of applications, and that the embodiments may take a wide range of modifications without departing from any inventive concept as defined in the appended claims.

1. A computer-implemented method for closed-loop control of a manufacturing process, the method comprising:
receiving, at predefined time intervals during the manufacturing process, at least one image of the manufacturing process;
processing, using a trained machine learning, ML, model, the at least one image at each time interval to predict a value of at least one manufacturing parameter associated with the manufacturing process;
determining whether the predicted value of the at least one manufacturing parameter is within a predefined range of values; and
generating instructions for corrective action when the predicted value is outside the predefined range of values.

2. The method as claimed in claim 1 wherein generating instructions for corrective action comprises generating instructions to adjust a value of at least one manufacturing parameter.

3. The method as claimed in claim 2 further comprising:
receiving confirmation that the value of the at least one manufacturing parameter has been adjusted; and
processing at least one image using the trained machine learning, ML, model, that is received after the confirmation has been received.

4. The method as claimed in claim 1 wherein generating instructions for corrective action comprises generating instructions to abort the current manufacturing process.

5. The method as claimed in claim 1 wherein receiving at least one image at predefined time intervals comprises receiving at least one image at predefined time intervals of between zero and ten seconds;
wherein receiving at least one image at predefined time intervals comprises receiving at least one image at predefined time intervals during at least an initial part of the manufacturing process.

6. (canceled)

7. The method as claimed in claim 1 further comprising:
sending instructions to pause the manufacturing process; and
performing the processing, determining and generating steps while the manufacturing process is paused.

8. The method as claimed in claim 1 wherein processing the at least one image using a trained machine learning, ML, model comprises processing the at least one image using a classification module or regression module of the trained ML model to predict a value of the at least one manufacturing parameter.

9. The method as claimed in claim 1 wherein the method is performed in real-time, to enable real-time control of the manufacturing process.

10. The method as claimed in claim 1 wherein the method is performed after the manufacturing process has ended, to enable control of a subsequent iteration of the manufacturing process.

11. The method as claimed in claim 1 wherein the manufacturing process is an extrusion-based 3D printing process;
wherein the at least one manufacturing parameter is any of: a flow rate; a lateral speed or feed rate; a Z-axis offset; a hotend temperature; a bed temperature; a layer height; a line width;
an infill density; a wall thickness; and a retraction setting.

12-17. (canceled)

18. A system for closed-loop control of a manufacturing process, the system comprising:
an apparatus for performing the manufacturing process, the apparatus comprising:
at least one image capture device for capturing at least one image of the manufacturing process at predefined time intervals; and
a communication module for transmitting the at least one image for processing; and
a remote server comprising at least one processor coupled to memory and arranged to:
receive the at least one image of the manufacturing process from the apparatus;
process, using a trained machine learning, ML, model, the at least one image at each time interval to predict a value of at least one manufacturing parameter associated with the manufacturing process;
determine whether the predicted value of the at least one manufacturing parameter is within a predefined range of values; and
generate instructions for corrective action when the predicted value is outside the predefined range of values.

19. The system as claimed in claim 18 wherein the at least one processor is further arranged to:
transmit the generated instructions to the apparatus.

20. The system as claimed in claim 19 wherein the steps performed by the at least one processor are performed in real-time, and the generated instructions are transmitted while the manufacturing process is in progress.

21. The system as claimed in claim 20 wherein generating instructions for corrective action comprises generating instructions to adjust a value of at least one manufacturing parameter;
wherein the at least one processor is further arranged to:
receive confirmation, from the apparatus, that the value of the at least one manufacturing parameter has been adjusted; and
process at least one image using the trained machine learning, ML, model, that is received after the confirmation has been received.

22. (canceled)

23. The system as claimed in claim 20 wherein generating instructions for corrective action comprises generating instructions to abort the current manufacturing process.

24. The system as claimed in claim 18 wherein the steps performed by the at least one processor are performed after the manufacturing process has ended, and the generated instructions are transmitted before a subsequent iteration of the manufacturing process begins;
wherein generating instructions for corrective action comprises generating instructions to adjust a value of at least one manufacturing parameter of the subsequent iteration of the manufacturing process.

25. (canceled)

26. A computer-implemented method for training a machine learning, ML, model to enable closed-loop control of a manufacturing process, the method comprising:
obtaining a training dataset comprising a plurality of images of the manufacturing process, wherein each image is labelled with a plurality of manufacturing parameters associated with the manufacturing process and a timestamp;
training a machine learning, ML, model by:
inputting images from the training dataset into the ML model;
processing, using the ML model, an input image to identify one of the manufacturing parameters;
predicting, using the ML model, a value of each manufacturing parameter for the input image;
comparing the predicted values with the labels of the image; and
updating the ML model to reduce a difference between the predicted values and the labels of the image.

27. The method as claimed in claim 26, wherein the plurality of images in the training dataset comprises any one or more of: individual images, individual frames from a video, and videos comprising multiple frames;
wherein comparing the predicted values comprises comparing the predicted values with the labels of the image to generate a loss function, and training the ML model comprises using backpropagation to train the ML model to reduce the loss function.

28. (canceled)

29. The method as claimed in claim 26 wherein training the ML model further comprises training the ML model to generate corrective actions to correct errors at inference time.

30. The method as claimed in claims 26 wherein training the ML model comprises:
generating the ML model using a pre-trained network, wherein the pre-trained network is trained using a first training dataset representing a broad range of objects; and
training the ML model using a second training dataset representing a single object or family of objects.
